(19) United States
(12) Patent Application Publication
(10) Pub. No.: US 2007/0033881 A1
(43) Pub. Date: Feb. 15, 2007

(54) Safety and security block window system

(76) Inventor: Bethel White Love, Chicago, IL (US)

Correspondence Address: Hiram R. Peacock, 12655 S. Lowe Ave, Chicago, IL, 60628, US

(21) Appl. No.: 11/204,373

(22) Filed: Aug. 15, 2005

(51) Int. Cl. E06B 3/00

(52) U.S. Cl. 49/501

(57) ABSTRACT

A block window system that combines the security of a glass block window with the safety of a window that can be opened in case of emergency. An inner frame-carrying sash containing glass or acrylic blocks is mounted in a fixed outer, peripheral frame. The inner frame is inwardly pivotable with respect to the building, moving away from the outer frame opening to form at least a 90 degree angle, allowing quick egress through the window in case of fire or other emergency. When closed and locked, the inner frame is sealed in weather tight fashion inside the outer frame, maintaining the strength and security of a traditional glass block window.

### FIELD OF THE INVENTION

The present invention relates to window systems and particularly to safety and security window systems having fixed outer frames and relatively moveable inner frame assemblies.

### BACKGROUND—DISCUSSION OF PRIOR ART

Each year, countless break-ins, burglaries and acts of vandalism are reported, both in residential and commercial buildings. In many cases, windows, especially basement and first floor windows are prime targets because of their ease of access. Prior art window systems have provided various means for providing safety and security for windows. Numerous windows with attached bars or security gates provide security against break-ins and vandalism. Glass block windows also provide a comparable level of window security without the appearance of bars or gates, because of their fixed, rigid, permanent construction, and can additionally provide protection against hurricanes and other extreme weather conditions.

However, the additional security allowed by the fixed permanence of both block windows and windows with bars or gates, becomes a safety hazard when the room is threatened by fire or other hazardous condition that requires a quick escape. This shortcoming of these prior art window systems causes the persons inside the building to be hampered or prevented from easily exiting if a hazardous situation should arise.

It is impossible to escape a basement having traditional glass block windows in the event of a fire, or should residents flee to the basement in the event of an above ground break-in. Additionally, the vents in glass block windows are usually too small to properly ventilate a room in case of hazardous conditions such as a carbon monoxide leak, or even noxious fumes from fresh paint or cleaning chemicals.

Because traditional glass block windows do not open, some local fire codes may prevent their use in a location, especially where there is only one window in that room or area, and there is no other available fire escape exit as prescribed by law.

Thus the need exists for a security window system that not only deters break-ins, vandalism, and extreme weather conditions, but also has the ability to being opened like a traditional window (non-security window) in the event of a hazardous situation that requires a quick exit or a quick source of additional ventilation.

### OBJECTS AND ADVANTAGES

Accordingly, a primary object of the present invention is to provide the security of a fixed glass block window and the life saving capability of an emergency exit in an easy to open window system.

Another object is to provide a safety and security block window system that overcomes the shortcomings of the prior art safety and security window systems.

An additional object is to provide a safety and security window system that has the appearance of a traditional glass block window.

Another object is to provide a secure window for rooms or basements that can quickly and easily be opened in case of an emergency.

Another object is to provide a window system that can include prefabricated block panels or individual blocks.

Another object is to provide a safety and security window system that can be retro-fitted to replace an existing traditional window or glass block window, or alternatively be installed in a newly constructed building or window opening.

A further object is to provide a safety and security window system that has a variety of aesthetic options.

### SUMMARY

The present invention provides a safety and security block window system that has the function and appearance of a traditional glass block window, but is also useable as an emergency exit in case of fire or other hazardous condition.

The window system of the present invention includes an operable window sash comprised of glass or acrylic blocks, which is attached to an outer window frame, which is permanently affixed into an opening in the building structure. The outer frame and inner sash frame portions can be covered by the exterior brick or siding of the building in order to maintain the frameless appearance of a traditional glass block window. In one embodiment the window sash is hingedly connected to the outer frame, allowing the sash to open relative to the outer frame. Alternatively, the sash has a fixedly attached roll bar that is held in place by anchor brackets that are attached to the outer frame. The window system has a dual rodded locking mechanism to secure the operable window into the outer frame, so that window system retains the advantages and strength of a traditional glass block window. In locations where heightened security for the window is not required, the window system can alternatively be composed with acrylic blocks, which allow for a large variety of aesthetic options. Acrylic blocks are 75% lighter than glass blocks and can be more energy efficient. Use of acrylic blocks can greatly reduce the overall weight of the window, and therefore allow additional options in frame composition. Vinyl, which is available in several colors, can be used in place of extruded aluminum for the frame with the lighter weight of acrylic blocks. Use of acrylic blocks also increases the selection of available colors, sizes, shapes and thicknesses while maintaining a lower cost than glass blocks.

### BRIEF DESCRIPTION OF THE DRAWINGS

This invention, together with other objects, features, aspects and advantages thereof, will be more closely understood from the following descriptions, considered in conjunction with the accompanying drawings.

FIG. 1 illustrates a perspective view of one embodiment of the window sash and outer frame with a lock handle and how it may be opened;

FIG. 2 illustrates a perspective view of an alternative embodiment of the window system that is hingedly connected together and has a locking lever mechanism;

FIG. 3 is a cross sectional view of the window sash of FIG. 2, taken along the lines 3-3 with the window partially open;

FIG. 4 is a cross sectional view of the hinge and window system of FIG. 2 taken along the lines 4-4, with the window partially open;

FIG. 5 is a cross sectional view of the window sash and locking mechanism of FIG. 2 taken along the lines 9-9;

FIG. 6 is an enlarged and fragmentary view of the window sash of FIG. 1;

FIG. 7 is a top view of the cross section of FIG. 6 along the lines 7-7;

FIG. 8 is a view of the closed window system where the dual rods are locked into the outer frame of the window system;

FIG. 9 is a view of the open window system where the dual rods are retracted into the inner window sash;

FIG. 10 is a cross sectional view of the inner window sash of FIG. 9, taken along the lines 10-10.

### DETAILED DESCRIPTION—PREFERRED EMBODIMENTS

As required, detailed descriptions of the present invention are disclosed herein, however, it is to be understood that the disclosed embodiments are exemplary of the invention, which may be embodied in various forms. Therefore, specific structural and functional details disclosed herein are not to be interpreted as limiting, but merely as a basis for the claims and as a representative basis for showing one skilled in the art to variously employ the present invention in all appropriately detailed forms.

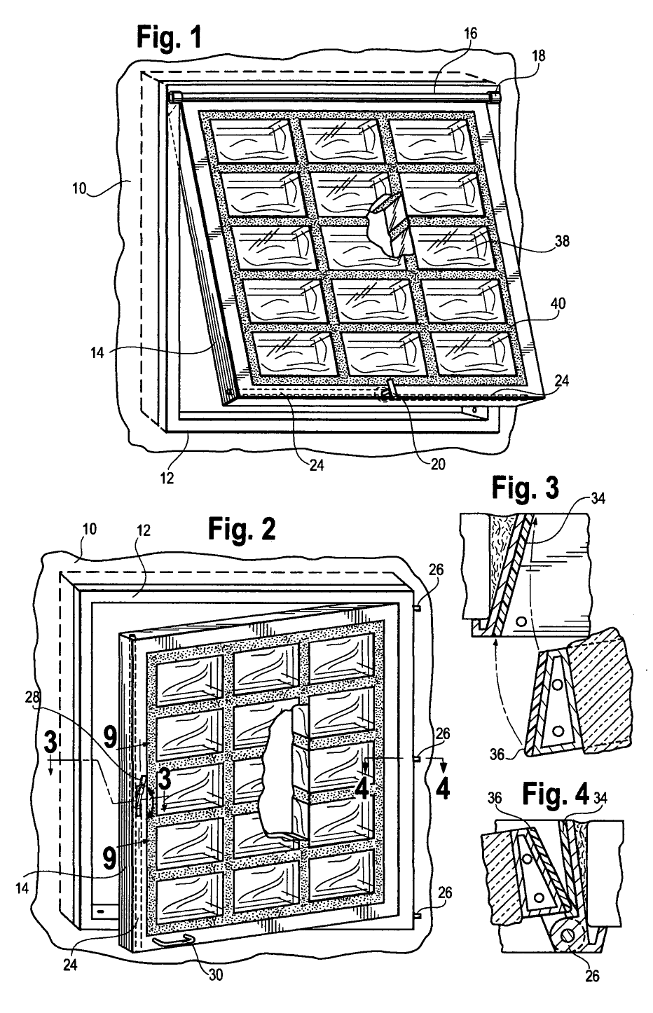

Referring to FIG. 1, the window system as illustrated has an outer window frame 12 mounted permanently in an opening in a wall 10 of a building structure. An inner window sash 14 is received within the outer frame 12. Both the outer window frame 12 and the inner window sash 14 may be extruded aluminum, vinyl, or other appropriate materials depending on the weight of the blocks used. The inner window sash 14 houses a plurality of glass or acrylic blocks 38 which are fixedly connected with a mortar or mortarless system 40 to form a panel of blocks that fills the inner window sash 14. Expansion strips are sandwiched between the inner window sash 14 and the plurality of window blocks 38 to help absorb any expansion of the blocks and maintain a proper seal within and around the plurality of window blocks 38. A roll bar 16 is rigidly connected across the top or bottom portion of the inner window sash 14, and supported by anchor brackets 18 that are fixedly attached to the outer window frame 12. The roll bar 16 allows the inner window sash 14 to swing inward from the top or bottom of the outer window frame 12 to allow egress to the exterior of the building. The lock handle 20, when in a vertical position can be used to lift or pull the inner window sash 14 until it forms a 90 degree angle with the outer window frame 12. The dual rod locking mechanism 22, as shown in detail in FIGS. 7 and 10, which is controlled by the lock handle 20 is disengaged and the dual rods 24 are retracted into the inside of the inner window sash 14. FIGS. 6 and 7 illustrate the lock handle 20 in a horizontal position and the dual rods 24 engaged into the outer window frame 12. FIG. 10 illustrates the dual rod locking mechanism 22 as the lock handle 20 moves it into the engaged and disengaged positions.

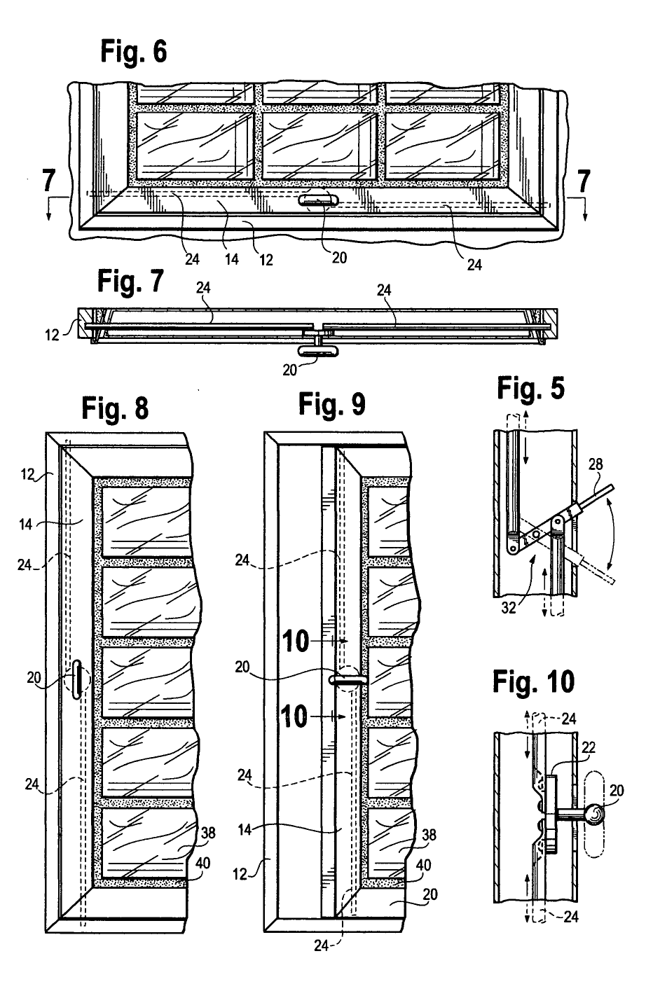

A preferred embodiment of the present invention is seen in FIG. 2. The partially open inner window sash 14 is connected to the outer window frame 12 by hinges 26, which can be extruded, piano, or other suitably strong hinges known to those skilled in the art, which allow the inner window sash 14 to swing inwardly from left to right (or right to left in transverse) to allow the inner window sash 14 to form at least a ninety degree angle with the outer window frame 12. The inner window sash can also be pulled open by the pull handle 30 once the lock lever 28 has been flipped to the released position. The lock lever 28 controls the dual rod locking lever mechanism 32(Seen in FIG.5), which when engaged, secures the inner window sash 14 to the outer window frame 12.

FIG. 3 shows a cross section view of the partially open sealing members of the inner and outer window of FIG. 2 at lines 3-3. FIG. 4 shows a cross section view of the hinges of FIG. 2 at line 4-4. FIG. 4 further illustrates the sealing members and hinge 26 as the window is partially closed. As seen in FIG. 3 and 4, the sealing members, both the outer frame sealing member 34 and the inner sash sealing member 36, which are disposed between the inner window sash 14, and the outer window frame 12 can be made of rubber or any other suitably resilient elastomeric materials known to those skilled in the art. The sealing members are compressed together when the window is closed to form a weather tight seal.

FIG. 5 illustrates the dual rod locking lever mechanism 32, which is unengaged when the lock lever 28 is in the up position, and engaged when the lock lever 28 is in the down position. When the dual rod locking lever mechanism 32 is engaged, the dual rods extend into the outer window, locking the inner window sash 14 inside the outer window frame 12. When the dual rod locking lever mechanism 32 is unengaged, the dual rods are retracted back into the inner window sash 14 so that the inner window sash 14 can be opened.

FIGS. 6 and 7 show a perspective and top cross section view of the closed window system with the lock handle 20 in the horizontal, engaged position, with the dual rods 24 and engaged into the outer window sash 12.

FIG. 7 shows a top view cross section of the window system and dual rods 24 of FIG. 6 at the lines 7-7 with the lock handle 20 in the horizontal, engaged position, with the dual rods 24 engaged into the outer window sash 12.

Referring now to FIGS. 8 and 9, another embodiment of the present invention shows the lock handle 20 and dual rod locking mechanism 22 on a side open version of the window system. Unlike the side open version of FIG. 2, a handle at the bottom of the window is unnecessary because of the lock handle 20, which can be grasped and used to open the window. In FIG. 8, the inner window sash 14 is closed and the lock handle 20 and dual rods 24 are in the engaged position. In FIG. 9, the window sash is partially open and the lock handle 20 and dual rod locking mechanism 22 are in the unengaged position. FIG. 10 shows an exploded view of the cross section of the dual rod locking mechanism 22 shown in FIG. 9 across the lines 10-10.

Any other convenient form or arrangement of locking means known to those skilled in the art could be employed, of course, the locking mechanism shown being presently preferred but not necessarily optimum. For instance, the lock mechanism could be provided to engage in the center of the outer window frame 12 instead of at the left and right or top and bottom extremities of the outer window frame 12, without departing from the principles of the present invention in any manner. Additionally, powered means, such as a pneumatic or electro-hydraulic assistance could be provided for lifting the inner window sash 14 of FIG. 1 and holding it into an open position.

While particular embodiments of the present invention have been shown and described, it will be obvious to those skilled in the art that other variations can be made without departing from the spirit of the invention as claimed. For example, the inner window sash 14 can comprise a panel of blocks and a vent as known in prior art block windows. Also an alarm mechanism can be added to signal the separation of the outer window frame 12 and the inner window sash 14 whenever the window is opened.

Conclusion, Ramifications and Scope

Accordingly, the reader will see that the block window system can be used to serve a variety of aesthetic and functional purposes. Not only does the window system allow for the stylistic preferences of the owner, but it also addresses the security and safety needs of the owner as well. Some of the additional advantages of the block window system are that
1. It allows for a range of colors for the block window system;
2. It allows for alternative shapes and designs of block windows;
3. It provides flexibility in the balancing of security, safety and beauty.

Although the description above contains many specificity's, these should not be construed as limiting the scope of the invention, but as merely providing illustrations of some of the presently preferred embodiments of this invention. For example, other types of hinges can replace the extruded hinges; the latching mechanism can be replaced by any other means of locking

Thus the scope of the invention should be determined by the appended claims and their legal equivalents, rather than by the examples given.

Drawings—List of Reference Numerals

10 wall
12 outer window frame
14 inner window sash
16 roll bar
18 anchor brackets
20 lock handle
22 dual rod locking mechanism
24 dual rods
26 hinge
28 lock lever
30 pull handle
32 dual rod locking lever mechanism
34 outer frame seal
36 inner sash seal
38 window blocks
40 mortar or mortarless connection system

What is claimed is:

1. A safety and security block window system comprising:
an outer window frame means having an interior and exterior portion, sized to be permanently mounted in an opening of a building;
a plurality of window blocks interconnected to form a window pane;
an inner window sash means having an interior and exterior portion, to be received within said frame means, said sash means being of sufficient depth and strength to accommodate said plurality of interconnected window blocks; and
a means for connecting said sash means to said frame means, said means for connecting allowing said sash means to open relative to said frame means.

2. A safety and security block window system according to claim 1, further including a latching means for securably sealing said sash means into said frame means.

3. A safety and security block window system according to claim 2, further including a resilient expansion means for sandwiching between said sash means and said window blocks to allow said window blocks to expand and contract with temperature changes.

4. A safety and security block window system according to claim 2 wherein said latching means is comprised of a locking lever and a dual rod locking lever mechanism.

5. A safety and security block window system according to claim 2 wherein said latching means is comprised of a lock handle and a dual rod locking mechanism.

6. A safety and security block window system according to claim 2 wherein said frame means has two generally circular holes of predetermined depth and width to accommodate said latching means when extended from opposite sides of said sash means.

7. A safety and security block window system according to claim 4 further including a pull handle that is fixedly attached to an appropriate portion of said sash means to assist in opening said sash means.

8. A safety and security block window system according to claim 3 wherein said means for connecting includes one or more extruded hinges connected to said frame means and said sash means to allow said sash means to open relative to said frame means.

9. A safety and security block window system according to claim 3 wherein said plurality of interconnected window blocks are interconnected by a mortar or mortarless system forming a sealed joint between each window block and by a mortar system forming a sealed joint between said plurality of interconnected window blocks and said sash means.

10. A safety and security block window system according to claim 2 wherein said plurality of interconnected window blocks are interconnected into a panel of blocks before being installed into said sash means.

11. A safety and security block window system according to claim 1 wherein the exterior portion of said frame means is narrower than the interior portion of said frame means, and the interior portion of said sash means is narrower than the exterior portion of said sash means.

12. A safety and security block window system according to claim 11, further including a first continuous, peripheral weather sealing means that is fixedly attached to said frame means, and a second continuous peripheral weather sealing means that is fixedly attached to said sash means for engaging said first weather sealing means and maintaining a weathertight seal when said first and second weather sealing means are contiguously engaged.

13. A safety and security block window system according to claim 1 wherein said plurality of window blocks are made of acrylic or other suitably lightweight generally transparent plastic materials.

14. A safety and security block window system according to claim 13 wherein said frame means and said sash means are made of vinyl or other suitably colorable synthetic materials.

15. A safety and security block window system according to claim 1 wherein said frame means and said sash means are made of extruded tubular aluminum or other suitably strong metals.

16. A safety and security block window system according to claim 15 wherein said plurality of window blocks is made of glass.

17. A safety and security block window system according to claim 1 wherein said means for connecting is a roll bar which is fixedly attached to said sash means and pivotally secured to said frame means by anchor brackets.

18. A safety and security block window system according to claim 1 wherein said means for connecting allows controlled movement of said sash means between a first position sealably engaged within said frame means, and a second position where said sash means forms at least a 90 degree angle relative to said frame means to form an opening within said frame means.

19. A safety and security block window system comprising:
a window frame to be permanently mounted in an opening of a structure;
a plurality of window blocks interconnected to form a window pane;
a window sash to be received within said window frame, said window sash being of sufficient depth and strength to accommodate said plurality of interconnected window blocks;
a connecting means for attaching said window sash to said window frame, with said connecting means for connecting allowing said window sash to open relative to said window frame; and
a latching means for securing said window sash inside said window frame when said window sash is in the closed position.

20. A safety and security block window system made by the process including the steps of comprising:
a) providing an outer window frame of generally rectangular shape to be inserted into an opening in a building,
b) providing an inner window sash for placement inside said window frame,
c) providing a plurality of window blocks to be placed inside said window sash to form a window pane,
d) providing an expansion means for placement between said window sash and said plurality of window blocks,
e) providing a connecting means for attaching said window sash to said window frame where said connecting means allows movement of said window sash relative to said window frame,
f) providing a lock handle for securing or releasing said window sash relative to said window frame,
g) inserting said plurality of window blocks into said window sash,
h) connecting said window sash to said window frame using said connecting means,
i) inserting said window sash into said window frame,
whereby said safety and security block window system can be used as a security window to prevent access from the outside by burglars and intruders, as well as a safety window in case of emergency to allow egress by releasing and opening said window sash with said lock handle and opening said window sash relative to the fixed position of said window frame.
